(19) United States
(12) Patent Application Publication
(10) Pub. No.: US 2018/0273079 A1
(43) Pub. Date: Sep. 27, 2018

(54) TRUCK STEERING WHEEL HUB ADAPTER

(71) Applicants: DIEGO JAIME VILLAMIZAR, MEDLEY, FL (US); JAIRO A. VILLAMIZAR, MEDLEY, FL (US); JOSE ANTONIO VILLAMIZAR, MEDLEY, FL (US)

(72) Inventors: DIEGO JAIME VILLAMIZAR, MEDLEY, FL (US); JAIRO A. VILLAMIZAR, MEDLEY, FL (US); JOSE ANTONIO VILLAMIZAR, MEDLEY, FL (US)

(21) Appl. No.: 15/467,941

(22) Filed: Mar. 23, 2017

(51) Int. Cl. B62D 1/10; F16D 1/076

(52) U.S. Cl. CPC B62D 1/10; F16D 1/076

(57) ABSTRACT

A truck steering wheel hub adapter that comprises of a hub adapter body having a top, a middle and a bottom, the top of the hub adapter body defines a steering wheel receiving circular plate that defines a first hole receiving arrangement and a second hole receiving arrangement and the steering wheel receiving circular plate defines a central axis point, the first hole receiving arrangement defines a first set of three apertures having a central axis point that are equally spaced apart from each other and that are all equally distant from the central axis of the steering wheel receiving circular plate, the second hole receiving arrangement defines a second set of five apertures having a central axis point that are equally spaced apart from each other and that are all equally distant from the central axis of the steering wheel receiving circular plate and they are arranged in a staggered position from the first hole receiving arrangement and are in a position that is further out from the central axis than the first hole receiving arrangement, the middle section of the body is an extension of the hub adapter body has at least one hollow interior space that allows a wire or a connector to be placed within the hub adapter body, the bottom section defines a spline that connects to a shaft of a truck.

### BACKGROUND

The present invention is directed to a truck steering wheel hub adapter that has a universal bolt receiving arrangement for steering wheel having a three-hole or a five-hole securing arrangement.

Many truck steering wheels either use a three-hole, a five-hole or an eight-hole securing arrangement. In either arrangement, the three-hole or the five-hole securing arrangement is arranged so that each hole is equidistant from each adjoining whole around the circumference of a central axis.

In the aftermarket industry, many truck drivers purchase after-market steering wheels to improve the look and/or feel of their trucks. Often, the after-market steering wheels require the trucks in which they are to be installed to be fit with hub adapters that will receive the steering wheels, for the original hubs do not accommodate the after-market steering wheels.

The present invention provides and after-market hub adapter that will receive a steering wheel having a three-hole or a five-hole securing arrangement.

For the foregoing reasons there is a need for a truck steering wheel hub that has a universal bolt receiving arrangement that will accommodate after-market steering wheels having either a three-hole or a five-hole securing arrangement.

### SUMMARY

The present invention describes a truck steering wheel hub adapter that has a universal bolt receiving arrangement that will accommodate a steering wheel that defines either a three or a five hole securing arrangement.

The present invention is a truck steering wheel hub adapter that comprises of a hub adapter body having a top, a middle and a bottom, the top of the hub adapter body defines a steering wheel receiving circular plate that defines a first hole receiving arrangement and a second hole receiving arrangement and the steering wheel receiving circular plate defines a central axis point, the first hole receiving arrangement defines a first set of three apertures having a central axis point that are equally spaced apart from each other and that are all equally distant from the central axis of the steering wheel receiving circular plate, the second hole receiving arrangement defines a second set of five apertures having a central axis point that are equally spaced apart from each other and that are all equally distant from the central axis of the steering wheel receiving circular plate and they are arranged in a staggered position from the first hole receiving arrangement and are in a position that is further out from the central axis of the steering wheel circular plate than the first hole receiving arrangement, the middle section of the body is an extension of the hub adapter body has at least one hollow interior space that allows a wire or a connector to be placed within the hub adapter body, the bottom section defines a spline that connects to a shaft of a truck.

In a preferred embodiment the hub adapter is made of forged steel and the distance from the central axis of the of the steering wheel receiving circular plate to each aperture's central axis point of the first arrangement is 31.25 millimeters and the distance from the central axis of the of the steering wheel receiving circular plate to each aperture's central axis point of the second arrangement is 35.90 millimeters.

An object of the present invention is to provide a truck steering wheel hub adapter that has a universal bolt receiving arrangement that will accommodate a steering wheel that defines either a three-hole or a five-hole securing arrangement.

Another object of the present invention is a truck steering wheel hub adapter that will allow installers of after-market steering wheels with a truck steering wheel hub adapter that will accommodate after-market steering wheels having at least two different securing arrangements.

### DRAWINGS

These and other features, aspects, and advantages of the present invention will become better understood with regard to the following description, appended claims, and drawings where:

FIG. 1 is a top perspective view of a truck steering wheel hub adapter;

FIG. 2 is a bottom plan view of an embodiment of the truck steering wheel hub adapter;

FIG. 3 is a perspective view that shows how the present invention would be connected on a truck using a three hole steering wheel;

FIG. 4 is a perspective view that shows how the present invention would be connected on a truck using a five hole steering wheel; and

FIG. 5 is a perspective view that shows how the present invention would be connected on a truck using a eight hole steering wheel.

### DESCRIPTION

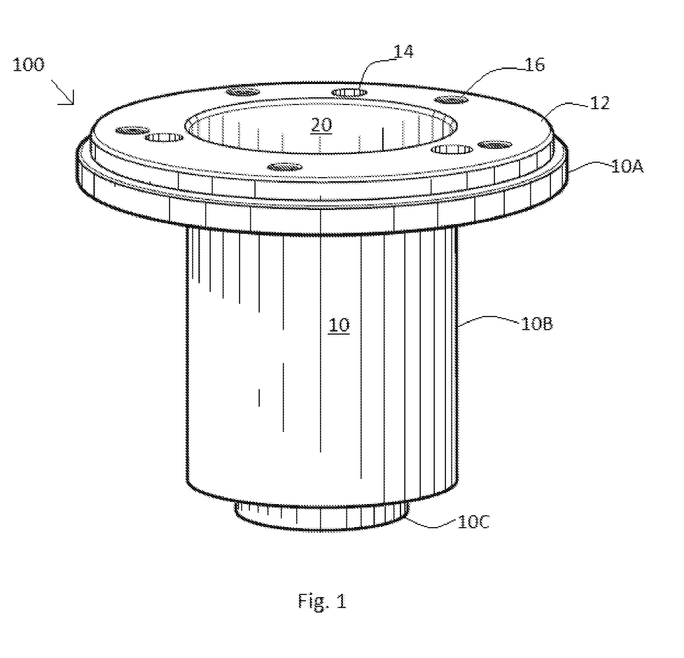

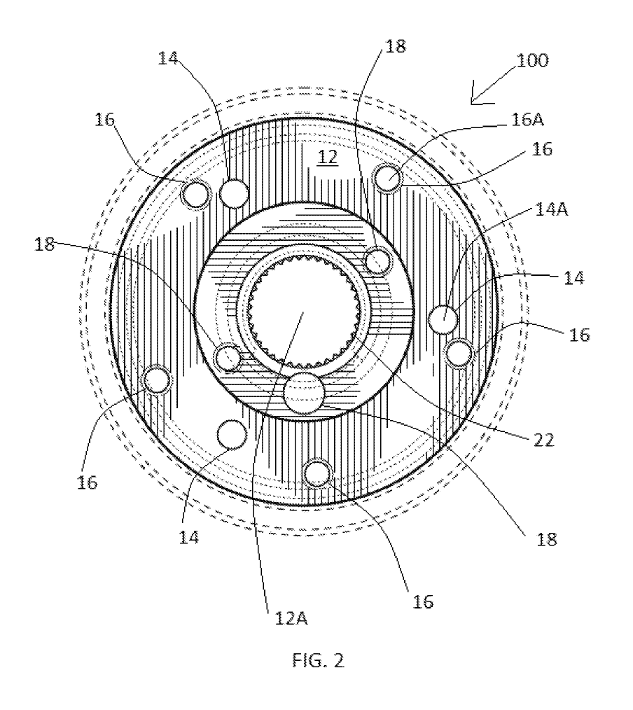

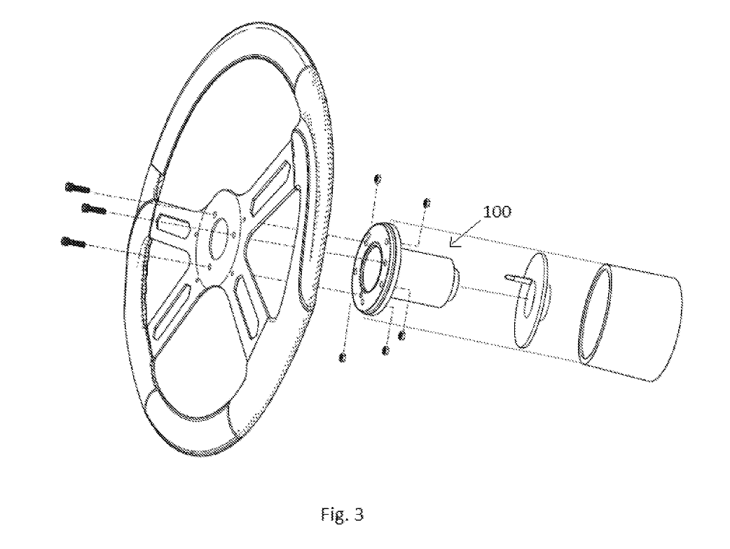

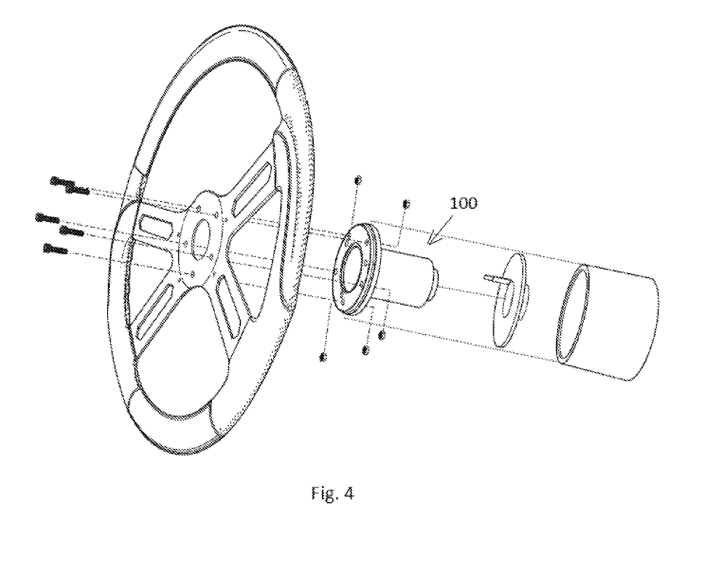

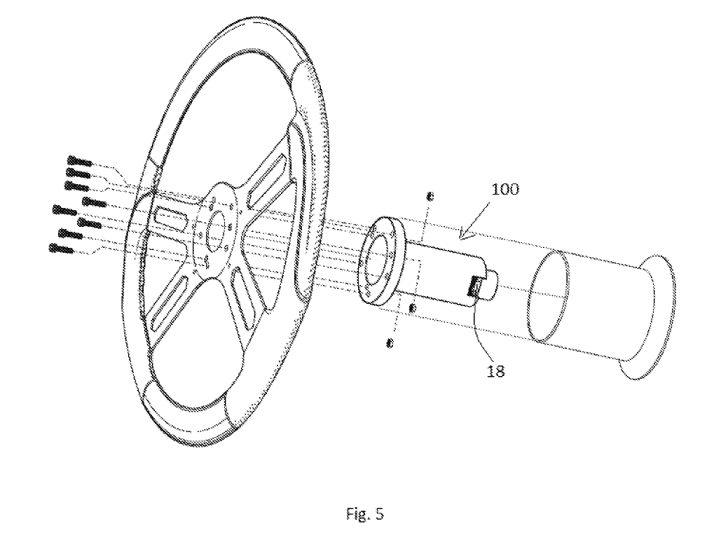

As seen in FIGS. 1-5, the present invention is a truck steering wheel hub adapter 100. The truck steering wheel hub adapter 100 comprises of a hub adapter body 10 having a top 10A, a middle 1013 and a bottom 10C, the top of the hub adapter body 10A defines a steering wheel receiving circular plate 12 that defines a first hole receiving arrangement 14 and a second hole receiving arrangement 16 and the steering wheel receiving circular plate 12 defines a central axis point 20, the first hole receiving arrangement 14 defines a first set of three apertures 14 having a central axis point 14A that are equally spaced apart from each other and that are all equally distant from the central axis 20 of the steering wheel receiving circular plate 12, the second hole receiving arrangement 16 defines a second set of five apertures 16 having a central axis point 16A that are equally spaced apart from each other and that are all equally distant from the central axis 20 of the steering wheel receiving circular plate 12 and they are arranged in a staggered position from the first hole receiving arrangement 14 and are in a position that is further out from the central axis 20 of the steering wheel circular plate 12 than the first hole receiving arrangement 14, the middle section of the body 1013 is an extension of the hub adapter body 10 has at least one hollow interior space 18 that allows a wire or a connector to be placed within the hub adapter body 10, the bottom section 10C defines a spline 22 that connects to a shaft of a truck.

In a preferred embodiment of the present invention, the hub adapter is made of forged steel.

In another preferred embodiment, the distance from the central axis 20 of the of the steering wheel receiving circular plate 12 to each aperture's central axis point of the first arrangement is 31.25 millimeters and the distance from the central axis 20 of the of the steering wheel receiving circular plate 12 to each aperture's central axis point of the second arrangement is 35.90 millimeters.

An advantage of the present invention is that it provides a truck steering wheel hub adapter that has a universal bolt receiving arrangement that accommodates a steering wheel that defines either a three-hole or a five-hole securing arrangement.

Another advantage of the present invention is that it provides truck steering wheel hub adapter that allows installers of after-market steering wheels with a truck steering wheel hub adapter that accommodates after-market steering wheels having at least two different securing arrangements.

While the inventor's above description contains many specificities, these should not be construed as limitations on the scope, but rather as an exemplification of several preferred embodiments thereof. Many other variations are possible. For example, the present invention can be described to accommodate steering wheel having random hole spacing that corresponds to the truck steering wheel hub adapter of the present invention. Accordingly, the scope should not be determined by the embodiments illustrated, but by the appended claims and their legal equivalents.

What is claimed is:

1. A truck steering wheel hub adapter, the hub adapter comprises:
a hub adapter body having a top, a middle and a bottom, the top of the hub adapter body defines a steering wheel receiving circular plate that defines a first hole receiving arrangement and a second hole receiving arrangement and the steering wheel receiving circular plate defines a central axis point, the first hole receiving arrangement defines a first set of three apertures having a central axis point that are equally spaced apart from each other and that are all equally distant from the central axis of the steering wheel receiving circular plate, the second hole receiving arrangement defines a second set of five apertures having a central axis point that are equally spaced apart from each other and that are all equally distant from the central axis of the steering wheel receiving circular plate and they are arranged in a staggered position from the first hole receiving arrangement and are in a position that is further out from the central axis of the steering wheel circular plate than the first hole receiving arrangement, the middle section of the body is an extension of the hub adapter body has at least one hollow interior space that allows a wire or a connector to be placed within the hub adapter body, the bottom section defines a spline that connects to a shaft of a truck.

2. The truck steering wheel hub adapter of claim 1, wherein the hub adapter is made of forged steel.

3. The truck steering wheel hub adapter of claim 1, wherein the distance from the central axis of the of the steering wheel receiving circular plate to each aperture's central axis point of the first arrangement is 31.25 millimeters and the distance from the central axis of the of the steering wheel receiving circular plate to each aperture's central axis point of the second arrangement is 35.90 millimeters.
